(19) United States
(12) Patent Application Publication
(10) Pub. No.: US 2007/0036333 A1
(43) Pub. Date: Feb. 15, 2007

(54) Method of handling overflow calls

(75) Inventor: Joseph F. Albert, Huntington, NY (US)

Correspondence Address: EPSTEIN DRANGEL BAZERMAN & JAMES, LLP, 60 EAST 42ND STREET, SUITE 820, NEW YORK, NY, 10165, US

(73) Assignee: Overlflow, Inc.

(21) Appl. No.: 11/182,416

(22) Filed: Jul. 15, 2005

(51) Int. Cl. H04M 3/00; H04M 5/00

(52) U.S. Cl. 379/266.01; 379/265.01

(57) ABSTRACT

A method of handling excess telephone calls from a caller to an information providing center of an entity in which it is determined if a call to the information providing center of the called entity cannot immediately be answered by the information providing center. If not, the call is automatically routed to a call forwarding center. At the call forwarding center, an agent having a computer and not employed by the called entity is selected. The call is forwarded from the call forwarding center to the selected agent via the Internet. The call is answered by the agent to ascertain the information sought by the caller. The selected agent accesses his or her computer to obtain the sought after information. The information in the computer that is to be accessible by the agent is predetermined by the entity. If present in the computer, the selected agent provides the accessed information to the caller.

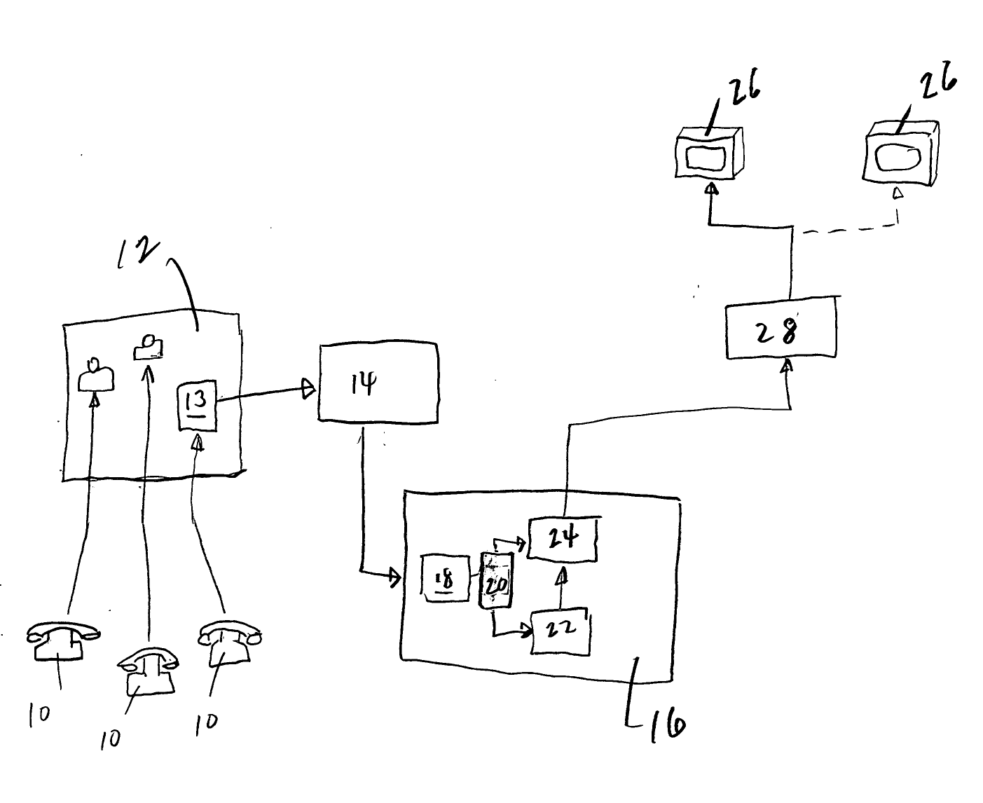

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to methods of responding to telephone inquiries seeking information from an entity, such as a commercial establishment or government agency, and more particularly to a method for handling such telephone inquires that cannot be immediately answered by the entity for various reasons, such as lack of available personnel, insufficient telephone system capacity or the like.

2. Description of Prior Art Including Information Disclosed Under 37 CFR 1.97 and 1.98

Commercial establishments such as retail stores receive large numbers of telephone calls seeking a variety of different types of information such as the hours of operation or the availability of certain merchandise. Transportation companies receive many telephone calls requesting train or bus schedules, fare information, updates on weather related delays and the like. Similarly, governmental agencies receive telephone inquires asking for information about refuse recycling requirements, tax payment deadlines, road closings due to repairs and many other subjects.

Such entities commonly employ telephone operators to answer such calls. However, the number of operators employed by the entity that are available to answer the telephone calls at any one time, and the capacity of the telephone system hardware used by the entity to receive such calls, are necessarily limited by financial and physical constraints. Accordingly, many such telephone calls cannot be answered immediately by entity personnel, particularly during high volume periods. The result is that callers are “put on hold” or receive a busy signal, such that the call is not answered at all. That leads to frustration on the part of the caller, who may simply decide to take his or her business elsewhere, or to look for a different, less efficient way to obtain the information that is needed.

The present invention relates to. a system for handling such excess or overflow calls.

It is therefore a prime object of the present invention to provide a method of handling overflow calls that eliminates the necessity for putting on hold calls that are beyond the immediate answering capacity of the call receiving entity or not answering them at all.

It is another object of the present invention to provide a method of handling overflow calls that requires the entity to pay a fee based only on the number of overflow calls answered.

It is another object of the present invention to provide a method of handling overflow calls that does not require the call receiving entity to hire additional personnel or to make capital investment in higher capacity telephone equipment.

It is another object of the present invention to provide a method of handling overflow calls that is transparent to the caller.

It is another object of the present invention to provide a method of handling overflow calls that utilizes personnel to respond to overflow calls that are not located at premises of the entity or in its employ.

It is another object of the present invention to provide a method of handling overflow calls that utilizes personnel with characteristics that can be chosen by the entity and therefore customized for the needs of the entity.

It is another object of the present invention to provide a method of handling overflow calls that permits the entity total control over the information that can be provided to the caller.

It is still another object of the present invention to provide a method of handling overflow calls that provides gainful employment to home-bound individuals such as handicapped or retired persons.

### BRIEF SUMMARY OF THE INVENTION

In accordance with the present invention, a method is provided for handling excess telephone calls from a caller to the information providing center of an entity. The method includes the steps of determining if a call to the information providing center of the entity cannot be answered immediately by the information providing center. If it is determined that the call cannot be answered immediately by the information providing center of the entity, the call is routed to a call forwarding center. The call forwarding center forwards the call to a selected agent not in the employ of the entity. The agent answers the call and ascertains the information sought by the caller. The agent accesses a computer to obtain the information sought. The information will be accessible to the agent from the computer only if the information has been predetermined by the entity as being available to the agent. The agent then provides the accessed information to the caller.

The step of routing the call to a call forwarding center includes the step of automatically routing the call from the information providing center to the call forwarding center over a telecommunications system.

The step of forwarding the call includes the steps of receiving the call at the call forwarding center server, selecting an agent to handle the call and routing the call over the Internet to the computer of the agent.

The step of predetermining the information accessible to the agent includes the steps of the entity determining which information should be provided by the agent to the caller; storing the information in a database; and downloading the database into the agent's computer.

The step of downloading the database includes the step of transmitting the information in the database from the computer of the entity to the computer of the agent.

The step of downloading the database includes the step of routing the transmitted information from the computer of the entity to the agent's computer, through the call forwarding center.

The method further includes the step of recruiting home bound individuals with computers to be agents. Such individuals may be physically handicapped or retired.

The steps of routing the call to the call forwarding center and forwarding the call from the call forwarding center to the selected agent are performed without knowledge of the caller and hence are transparent to the caller.

The method further includes the step of collecting a fee from the entity for each call answered by an agent. The method also includes the step of paying the agent for each call answered.

### BRIEF DESCRIPTION OF THE DRAWING

To these and to such other objects that may hereinafter appears, the present invention relates to a method of handling overflow calls as described in detail in the following specification and recited in the annexed claims, taken together with the accompanying drawing which illustrates the various steps of the method of the present invention.

### DETAILED DESCRIPTION OF THE INVENTION

As depicted in the drawing, the present invention is a method for handling telephone calls from one or more callers 10 to the information providing center 12 of an entity that are beyond the capacity of the information providing center to answer immediately. First, it is determined if operators 11 at information providing center 12 are available to immediately answer the calls from callers 10. If a call from caller 10 to the information providing center 12 cannot be answered immediately by information providing center 12, because of lack of operators or telephone system hardware capacity, the call is “flagged” and automatically routed by a call forwarding device 13 through a telecommunications network 14 to a remotely located call forwarding center 16, which includes a PBX (private branch exchange) 18 connected to a switch 20, a server 22 and a router 24.

Call forwarding center 16 selects a remotely located agent with a computer 26, not in the employ of the called entity, and forwards the call via an ISP (Internet service Provider) 28 to the selected agent, preferably using a VoIP or other digital telephone Internet system. This is accomplished automatically by server 22 that has stored therein a list of possible agents, along with the characteristics of each agent, so that the agent selection process can be customized for each called entity. The server also keeps track of which agents are currently answering overflow calls and therefore knows which agents are available to handle the next overflow call.

An agent with computer 26 is selected only if he or she is available, that is, is not answering another call. The selected agent must have a computer 26 with stored information previously provided by the entity being called so that the information sought by the caller can be retrieved by the selected agent from the computer. He or she must also possess any additional characteristics designated by the called entity. Such characteristics might include the capability of understanding a particular foreign language, or the ability to speak with a particular dialect or accent that might be common to the area in which the called entity is located.

For example, if the entity being called is a department store situated in the state of Alabama, the entity might specify that the agents answering its overflow calls have a southern accent because in order to give callers the impression that they are talking to someone local, regardless of the actual location of the agent. Similarly, a store that specializes in goods imported from France might want the agents handling its overflow calls to speak French or to have a French accent. On the other hand, a government agency might request that the agents responding to its overflow calls be of a particular sex or speak with an authoritative voice.

The overflow call is routed to the selected agent with computer 26 automatically and virtually instantaneously. In that way, the connection to the agent, who is not located on the premises of the called entity, is transparent to the caller. The caller has no reason to suspect that his or her call has not being answered by an operator in the employ and/or on the premises of the called entity.

The selected agent with computer 26 answers the transferred overflow call and ascertains the information sought by the caller. The agent accesses his or her preprogrammed computer 26 to obtain the information sought by the caller. The information will be accessible to the agent from his or her computer 26 only if the information has been predetermined by the called entity as being the type of information that the called entity wants the selected agent to provide to callers. This provides the called entity with absolute control over the information provided by the agents. The agent then provides the accessed information to the caller.

The ability of the called entity to control the information that the agent is capable of providing to a caller is an important feature of the present invention. For example, if the called entity is a computer hardware manufacturer, it might want the agent to provide information relating to inventory, such as the availability for shipment of a particular display, or the status of a previously placed order, but not want the agents to provide any technical information as to how to deal with a installation problems, for example, how to adapt a display for connection to a particular CPU. For the latter inquiry, the computer of the agent does not contain the information and may prompt the agent to refer the caller to a different telephone number or to an Internet website. Similarly, if the called entity is a police department, it might want the agents to field 311-type calls, for example, provide the telephone number of the department where potholes are reported, but not 911-type calls for emergency assistance.

Accordingly, the information accessible to the selected agent through his or her computer 26 is in all cases predetermined by the called entity. Before any calls are routed to an agent, the called entity prepares an available information database by storing in that database only the information that it wants the agents to provide to the callers. That database is then transferred to the call forwarding center 16 which in turn causes it to be downloaded into the computers 26 of the potential agents that may be selected for handling overflow calls for that particular database providing entity.

Another aspect of the method of the present invention relates to the agent recruiting process. Preferably, agents are obtained by recruiting home bound individuals with computers. Such individuals may be physically handicapped, retired or otherwise unemployable. The agents are trained as to how to answer the overflow calls, how to ascertain the information sought by the caller, how to access the database in their computer to obtain the information and how to provide the accessed information to the caller.

A fee is collected from the entity for each overflow call routed through the call forwarding center 16 and answered by an agent. The agent is paid a portion of the fee collected from the entity for each call answered by the agent. The system operator retains the remainder of the fee collected from the entity.

It will now be appreciated that the present invention is a method of handling excess telephone calls from a caller to an information providing center of an entity. The method includes the steps of: determining if a call to the information providing center cannot immediately be answered by the information providing center; routing the call to a call forwarding center, if it is determined that the call cannot be immediately be answered by the information providing center; forwarding the call from the call forwarding center to a selected agent not in the employ of the entity, answering the call by the agent to ascertain the information sought by the caller; accessing a computer by the agent to obtain the sought after information; predetermining, by the entity, the information in the computer that is to be accessible by the agent; and providing the accessed information to the caller, by the agent.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A method of handling a telephone call from a caller to the information providing center of an entity, comprising the steps of:
determining if the call to the information providing center cannot immediately be answered by the information providing center of the called entity;
routing the call from the information providing center of the entity to a call forwarding center, if it is determined that the call cannot be immediately answered by the information providing center of the called entity;
selecting an agent with a computer that is not in the employ of the called entity;
forwarding the call from the call forwarding center to a selected agent,
answering the call by the selected agent to ascertain the information sought by the caller;
accessing the computer of the selected agent, by the selected agent, to obtain the information sought by the caller;
predetermining, by the entity, the information in the computer that is to be accessible by the agent; and
providing the accessed information to the caller, by the agent.

2. The method of claim 1 wherein the step of routing the call to a call forwarding center comprises the steps of automatically routing the call from the information providing center to the call forwarding center over a telecommunications system.

3. The method of claim 1 wherein the step of forwarding the call comprises the steps of receiving the call at the call forwarding center server and routing the call over the Internet to the computer of the selected agent.

4. The method of claim 1 wherein the step of predetermining the accessible information comprises the steps of: the entity determining which information should be provided to the caller by the agents answering calls to that entity; storing the information in a database; and downloading the database into the computers of potential selected agents.

5. The method of claim 4 wherein the step of downloading the database comprises the steps of transmitting the information in the database from the computer of the entity to the computers of potential selected agents.

6. The method of claim 5 wherein the step of downloading comprises the step of routing the transmitted information from the computer of the entity to the computers of the potential selected agents, through the call forwarding center.

7. The method of claim 1 further comprising the step of recruiting home bound individuals with computers to be agents.

8. The method of claim 7 wherein the home bound individuals are physically handicapped.

9. The method of claim 7 wherein the home bound individuals are retired.

10. The method of claim 1 wherein the steps of routing the call to the call forwarding center, selecting the agent and forwarding the call from the call forwarding center to the selected agent are performed without knowledge of the caller.

11. The method of claim 1 further comprising the step of collecting a fee from the entity for each call answered by an agent.

12. The method of claim 1 further comprising the step of paying the selected agent for each call answered.
